(19) United States
(12) Patent Application Publication
(10) Pub. No.: US 2016/0224767 A1
(43) Pub. Date: Aug. 4, 2016

(54) APPARATUS, SYSTEM, AND METHOD FOR INSTANTANEOUS AND NON-INSTANTANEOUS PROVIDING OF CONTENT RESPONSIVE TO A TRIGGER

(71) Applicant: Chad Steelberg, Newport Beach, CA (US)

(72) Inventor: Chad Steelberg, Newport Beach, CA (US)

(21) Appl. No.: 14/930,215

(22) Filed: Nov. 2, 2015

Related U.S. Application Data
(60) Provisional application No. 62/073,530, filed on Oct. 31, 2014.

(51) Int. Cl. G06F 21/10

(52) U.S. Cl. CPC G06F 21/10; G06F 2221/0731

(57) ABSTRACT

The present invention is and includes an apparatus, system and method of providing a software platform that allows the publisher or requester of content, such as a private or commercial publisher, to set access restrictions to the content or on the generation thereof.

### RELATED APPLICATIONS

This application claims priority to U.S. Provisional Application Ser. No. 62/073,530, filed Oct. 31, 2014, which claims the benefit, as a continuation-in-part, of U.S. patent application Ser. No. 14/260,939 filed Apr. 24, 2014, which are hereby incorporated by reference in their entireties.

### BACKGROUND OF THE INVENTION

1. Field of the Invention

The present invention is directed to the providing of content, and, more particularly, to an apparatus, system and method for instantaneous and/or non-instantaneous providing of content responsive to a trigger.

2. Description of the Background

Today, social media has become a game of speed, both in terms of publishing/sharing, and accessing, content. For example, successful providers, such as Instagram, have simplified and accelerated certain processes, such as the image sharing process, in order to compete in this game of speed. Other mobile applications, or “apps,” such as SnapChat, may allow for these certain processes, such as the aforementioned image sharing process, to be subject to control of length of time “to live,” i.e., the publisher of content may set a time to live value for the content on a media.

More particularly, in embodiments such as the foregoing, when a consumer of the content views it, a timer may be triggered and the content deleted from the media outlet/host device once the specified time expires. Thereby, the “forever” aspect of content on the Internet is eliminated, and review of content by other than the initially consuming party/parties, such as by parents, is prevented.

However, such embodiments do not typically serve the converse purpose, namely to avoid providing content, only providing requested content, or progressively providing content, until the expiration of a time period, or upon occurrence of or in satisfaction of a trigger or criteria. And, more particularly, the known art does not provide a non-instantaneous reveal of content over a time period, upon occurrence of a series of trigger or over the course of a non-instantaneous trigger.

Thus, the need exists for an apparatus, system and method of providing at least a non-instantaneous reveal of content over a time period, upon occurrence of a series of trigger or over the course of a non-instantaneous trigger.

### SUMMARY OF THE INVENTION

The present invention is and includes an apparatus, system and method of providing a software platform that allows the publisher of content, such as a private or commercial publisher, to set access restrictions to the content, such as to de-obfuscate or obfuscate the content based upon achieving various criteria. For example, a publisher of social content may obfuscate the content until one or multiple criteria are met, upon which occurrence of the criteria a reveal of the content may occur. This reveal may be instantaneous, or, more preferably, gradual as the criteria is approached, or as ones of multiple criteria are met.

The present invention also is and includes an apparatus, executed on a mobile device by at least one processor resident thereon, comprising an electronic viewing module suitable for providing a view of content; a sending module suitable for sending at least one request for the content to at least one contact stored in a computing memory, wherein the request comprises criteria for generating the requested content; and a receiving module for receiving the requested content as indicative of an at least partial satisfaction of the criteria. The criteria may be, for example, a dare.

Thus, the present invention provides an apparatus, system and method of providing a reveal or generation of content over a time period, upon occurrence of a series of trigger or over the course of a non-instantaneous trigger.

### BRIEF DESCRIPTION OF THE FIGURES

The present invention will be described in conjunction with the incorporated figures, in which like numerals represent like elements, and in which:

FIG. 1 illustrates exemplary aspects of the present invention;

FIG. 2 illustrates exemplary aspects of the present invention;

FIG. 3 illustrates exemplary aspects of the present invention;

FIG. 4 illustrates exemplary aspects of the present invention;

FIG. 5 illustrates exemplary aspects of the present invention;

FIG. 6 illustrates exemplary aspects of the present invention;

FIG. 7 illustrates exemplary aspects of the present invention;

FIG. 8 illustrates exemplary aspects of the present invention;

FIG. 9 illustrates exemplary aspects of the present invention;

FIG. 10 illustrates exemplary aspects of the present invention;

FIG. 11 illustrates exemplary aspects of the present invention;

FIG. 12 illustrates exemplary aspects of the present invention;

FIG. 13 illustrates exemplary aspects of the present invention;

FIG. 14 illustrates exemplary aspects of the present invention;

FIG. 15 illustrates exemplary aspects of the present invention;

FIG. 16 illustrates exemplary aspects of the present invention;

FIG. 17 illustrates exemplary aspects of the present invention;

FIG. 18 illustrates exemplary aspects of the present invention;

FIG. 19 illustrates exemplary aspects of the present invention;

FIG. 20 illustrates exemplary aspects of the present invention;

FIG. 21 illustrates exemplary aspects of the present invention;

FIG. 22 illustrates exemplary aspects of the present invention;

FIG. 23 illustrates exemplary aspects of the present invention;

FIG. 24 illustrates exemplary aspects of the present invention;

FIG. 25 illustrates exemplary aspects of the present invention;

FIG. 26 illustrates exemplary aspects of the present invention;

FIG. 27 illustrates exemplary aspects of the present invention;

FIG. 28 illustrates exemplary aspects of the present invention;

FIG. 29 illustrates exemplary aspects of the present invention; and

FIG. 30 illustrates exemplary aspects of the present invention.

### DETAILED DESCRIPTION OF THE INVENTION

It is to be understood that the figures and descriptions provided herein may have been simplified to illustrate elements that are relevant for a clear understanding of the present invention, while eliminating, for the purpose of clarity, other elements found in typical systems and methods in the prior art. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such elements and steps may not be provided herein. The present disclosure is deemed to inherently include all such elements, variations, and modifications to the disclosed elements and methods that would be known to those of ordinary skill in the pertinent art.

Computer-implemented platforms, apparatuses, systems, and methods are disclosed for providing an instantaneous and/or non-instantaneous reveal of content over a time period, upon occurrence of a trigger or series of triggers, or over the course of a non-instantaneous trigger. This providing of content may occur intra-application (“app”), may be requested intra-app and delivered extra-app, may be requested extra-app and delivered intra-app, or may be requested and delivered extra-app, by way of example. As used herein, an app may preferably indicate an application on a mobile device, such as a smartphone, PDA, or a tablet computer, although, in certain embodiments an app may be partially or entirely included on a stationary device, such as a desktop or a laptop computer.

The described computer-implemented embodiments are intended to be exemplary and not limiting. As such, it is contemplated that the herein described systems and methods may be adapted to provide many types of users with access, delivery and/or reveal of many types of content, and can be extended to provide enhancements and/or additions to the exemplary content and/or content reveals described. The disclosed systems and methods are intended to encompass all such extensions, the protected scope of which are defined by the examples provided herein.

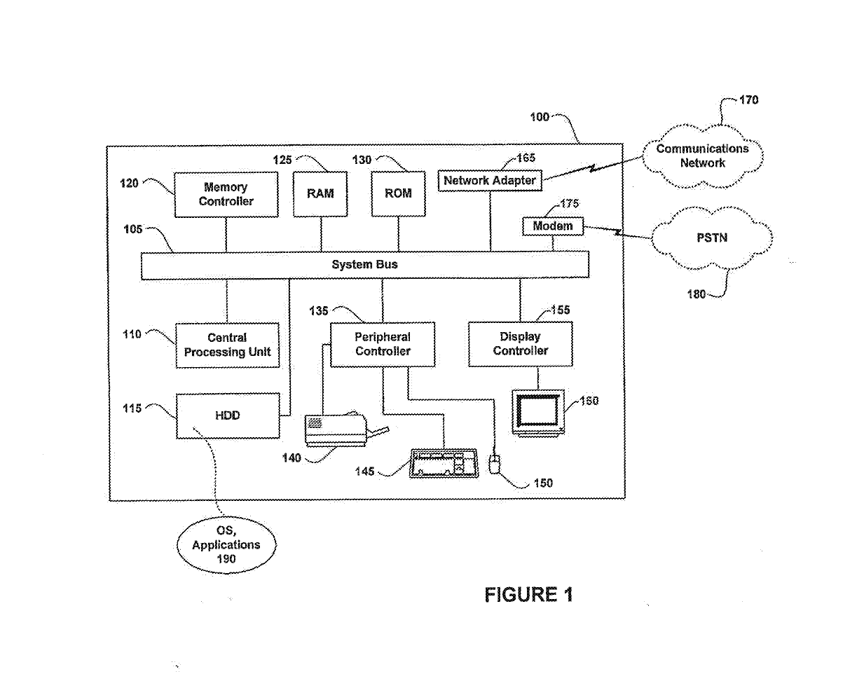

FIG. 1 depicts an exemplary computing system 100 that may be used in accordance with herein described apparatus, system and methods. Computing system 100 is capable of executing software, such as by providing an operating system (OS) and a variety of executable computing applications, or “apps,” 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel or touch display, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the data discussed herein. Communications network 170 may provide user access to computing system 100 with means of communicating and transferring software and information electronically, and may be coupled directly to computing system 100, or indirectly to computing system 100, such as via PSTN, WiFi, or cellular network 180. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations. That is to say, the inventive concepts described herein may be implemented in various computing environments using various components and configurations.

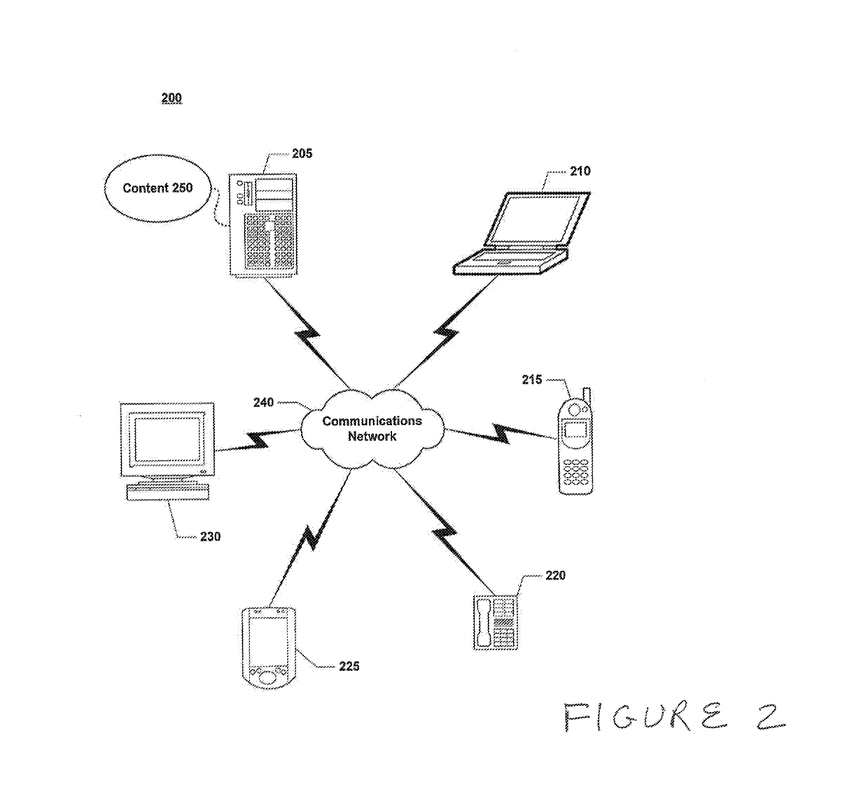

As shown in FIG. 2, computing system 100 may be deployed in networked computing environment 200. In general, the above description for computing system 100 applies to server, client, and peer computers deployed in a networked environment, for example, server 205, laptop computer 210, desktop computer 230, and various mobile computing devices 215. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone/smartphone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver and/or or communicate via applications specifically designed for mobile client devices, such as, for example, device 215. Client devices 215, 225 may be any mobile or stationary computer, computing device, telephone, PDA, tablet or smart phone and may have any device compatible operating system. Such operating systems may include, for example, Windows, Symbian, RIM Blackberry OS, Android, Apple iOS, Windows Phone, Palm webOS, Maemo, bada, MeeGo, Brew OS, and Linux. Although many mobile operating systems may be programmed in C++, some may be programmed in Java and .NET, for example. Some operating systems may or may not allow for the use of a proxy server and some may or may not have encryption. Of course, because many of the aforementioned operating systems are proprietary, in certain prior art embodiments server 205 delivers to client devices 215, 225 only those applications and that content applicable to the operating system and platform communication relevant to that client device 215, 225 type.

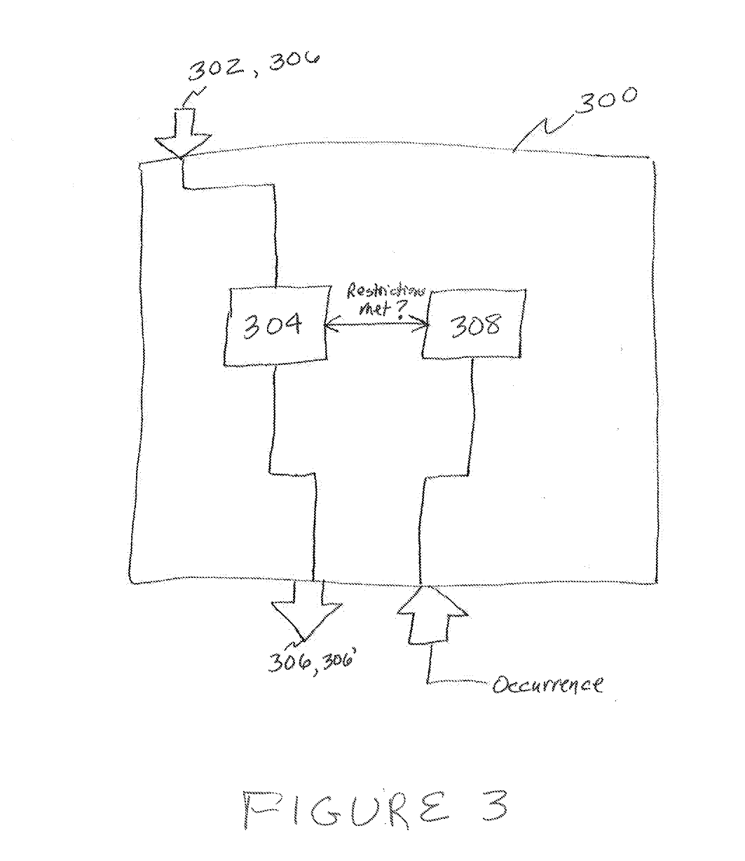

The present invention is and includes a software platform (i.e., server and client as described in FIGS. 1 and 2), such as is illustrated in the example of FIG. 3, that allows the publisher of content 302, such as a private or commercial publisher, to set access restrictions 304 to content 306, i.e., to obfuscate or inverse obfuscate, or take other action on, the content, based upon various criteria 308, such as triggers. For example, a publisher of social content may obfuscate the content until one or multiple criteria are met, upon which occurrence of the criteria a reveal of the content may occur. This reveal may be instantaneous, or, more preferably, gradual as the criteria is approached, or as ones of multiple criteria are met.

As used herein, an obfuscation may comprise any partial or total (such as blocking or non-delivery) modification of original content in such a manner so as to reduce/increase the visibility of the content (such as in the case of an image), so as to reduce/increase the understandability of the content (such as in the case of text, bar code, QR code, etc.), and/or so as to reduce/increase the usefulness or applicability of the content (such as in the case of a coupon of increasing value as criteria are met). By way of non-limiting example, an obfuscation may comprise a partially transparent overlay having a sufficiently high alpha to at least partially block content viewing. For example, an obfuscation may be a blurring, tiling, fading, or an animating affect that at least partially blocks or prevents consumption of the content by a viewer. An obfuscation may be instantaneous, or, more preferably, gradual. On the other hand, inverse obfuscation may comprise initially providing content as visible, and thereafter increasing, either instantaneously or gradually, the obfuscation as criteria are met. In certain exemplary embodiments discussed herein, progressive or instantaneous obfuscation is discussed, although those skilled in the pertinent arts will appreciate that such examples may likewise employ inverse obfuscation.

Obfuscation criteria may relate to the occurrence of events, time passage, triggers, or the like. Criteria may be binary (i.e., upon reaching the criteria, obfuscation is turned on or off) or progressive/cumulative (obfuscation or inverse obfuscation is progressed). Needless to say, progressive criteria may incentivize continuation of a single viewer's or multiple viewers' then-present behavior, such as incentivizing continued liking, presence, time passage, or the like. Criteria may comprise numerous available classes, such as social, temporal (within or outside of a time/date period), geographic, threshold (a certain number of correct answers on a test, for example), third party (such as integrated with third party apps), fee-based (any user who pays a fee, or after a certain number of users pay a fee, or a total amount in fees), or contest (win or lose).

For example, criteria, such as particularly social criteria, may include one or more of a “like” (or equivalent) threshold, dislikes, comments, links from/to, referrals from/to, or shares, and in accordance with the social criteria viewership may be limited to all invites or restricted to only those who meet (or who participated in the meeting of) the criteria. For example, a purely social criteria may include any viewers who have at least 500 friends on Facebook, or an image or image provider receiving 500, 1,000, or 10,000 “likes”. Simply put, social criteria may allow for a crowd sourcing of content de-obfuscation.

Geo-based criteria may include the presence of the viewer within/outside of a specific geoboundary. Further, geo-based criteria may include the presence (or absence) of specified viewers (either by number or by name) proximate to one another geographically, for example. For example, an image may progressively de-obfuscate once a prospective viewer is within 5 miles of a particular residence, progressing to complete de-obfuscation once the prospective viewer reaches the particular residence. By way of non-limiting example of combined social and geographic criteria, at least N people from the viewing list of M “friends” may be required to be within 100′ of each other in order for the N people (or all M people) to be enabled to view particular content.

Third party criteria may comprise third party app criteria. For example, a prospective viewer may be required to reach level 20 in the “Angry Birds” app in order to de-obfuscate content, or the content may progressively de-obfuscate as the viewer progresses from level 10 to level 20 in the same app. Accordingly, the computing system and network environment of FIGS. 1 and 2 may allow for third party web pages and/or app developers to make API calls for app status updates to the system (or device) of the present invention (i.e., to provide/receive an Angry Birds level indicator in the foregoing example). In other instances in which the third party already has public APIs, the present service may integrate via the APIs to pull statistics, such as likes, dislikes, shares, friends, etc. As such, the present invention provides an open platform for third parties to “snap in” events.

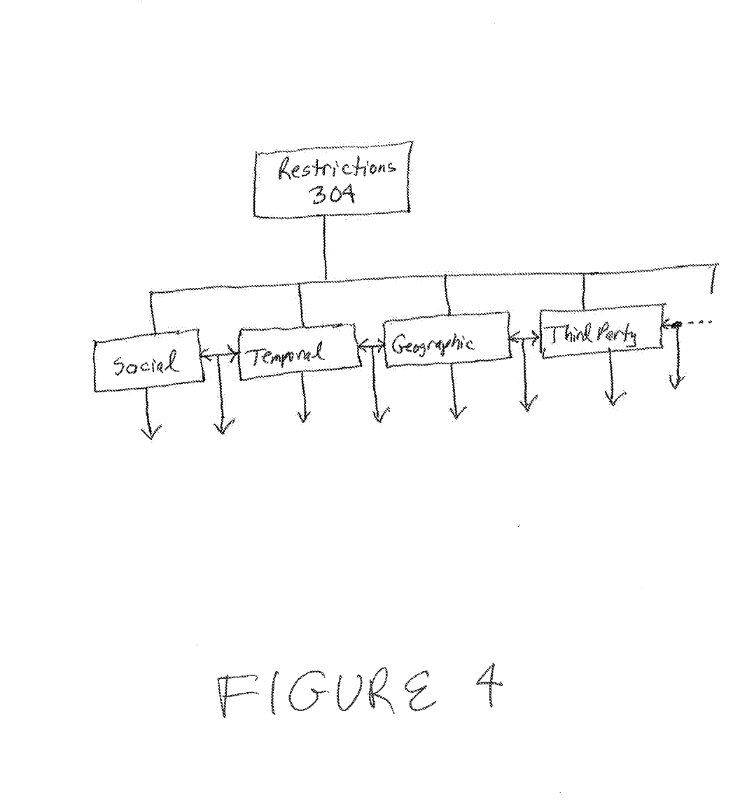

Needless to say, different categories of criteria may be applied, either in serial or in parallel, as referenced hereinabove, and as illustrated in FIG. 4. For example crowd sourcing (social criteria)-may allow for execution of micro-geo-based transactions (fee-based criteria), and such a micro-transaction may additionally include geo-based criteria. More specifically, for a reveal of a QR code that allows all recipients to receive a discount on a new micro-brewed beverage, the provider of the QR code may wish to receive 10,000 “likes” of its micro-brew, may wish to limit the discount to only those persons near the provider's location (i.e., in the greater Chicago metropolitan region), and may wish to raise $500 for an upcoming marketing campaign. As such, in order that viewers providing a “like” may receive a discount, certain viewers providing a like may also make a micro-donation, and likely most viewers providing a “like” will be in the Chicago area since only those users may receive the undefined “special gift” (i.e., the QR code indicating a discount) from the provider (of course, the criteria may be defined such that “likes” are, or are not, accepted from users outside of greater metropolitan Chicago).

Similarly, a large beer provider, such as Coors, may define criteria to reveal a coupon for free beer to viewers geo-based at a football game once 5,000 persons at the game entered a “like” on Facebook for Coors Light. As such, once 5,000 spectators deemed to be at the game entered a “like” of Coors Light on Facebook, all those entering a “like” may receive the coupon for a free beer. Similarly, once 4,000 likes were provided, the “reveal” may be progressive, in that 10% off a beer may be provided to those entering a “like” upon reaching 4,000 likes, with the percentage discount increasing progressively to 100% once 5,000 likes is reached.

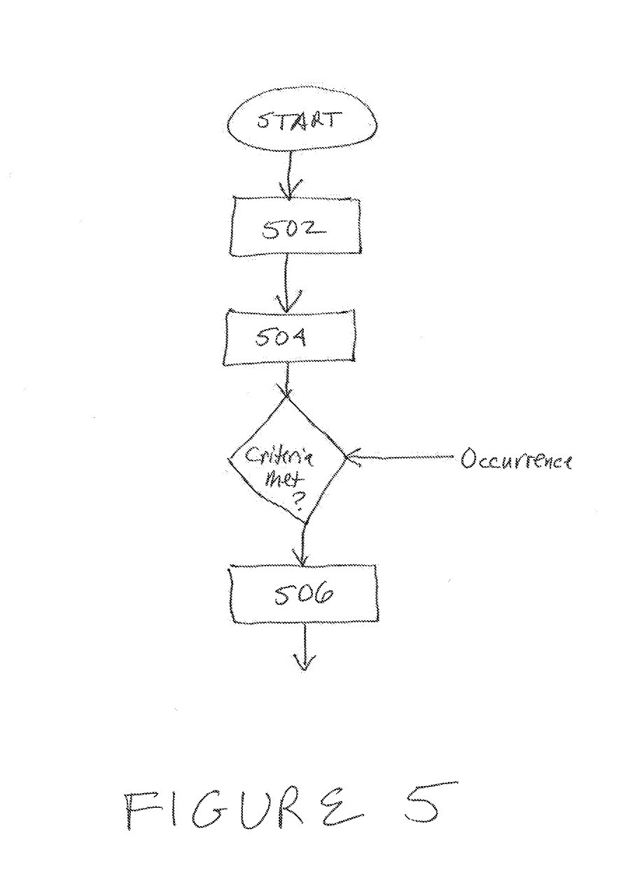

In an exemplary flow of a method in accordance with the system of FIG. 3, FIG. 5 illustrates that a user may take/receive/provide a photograph 502. Default or user-selectable obfuscation rules, and corresponded criteria, may be applied to the photo at 504. For example, the user may provide the photo, and may select “blur distortion”, a share group, 100 likes as the viewing criteria, and a progressive reveal of the image (i.e., not a binary reveal) based on a progressive meeting of the criteria. The photo may be revealed progressively, as the criteria are met, at least to the participating prospective viewers, at 506.

Further, for example, a photo share group may be selected as public. A first public user who views the photo sees a blurred image, and receives the criteria to see the photo clearly (in this example, 100 likes). Once the first user “likes” the image, the image may immediately become less blurred, such as by 1% (i.e., based on receipt of 1 out of the required 100 likes). Of course, those skilled in the art will appreciate that the relationship between the criteria and a gradual reveal may be non-linear, i.e., the first user may see a 5% reveal, and the last of the 100 users may see a 0.5% reveal, or the first user may see a 0.5% reveal and the last of the 100 users may see a 5% reveal. In any event, as more users like the image, the image progressively becomes more clear. Upon progression toward meeting the criteria, prior users may be provided with, for example, spark lines, notifications, or the like that a more complete reveal is progressing.

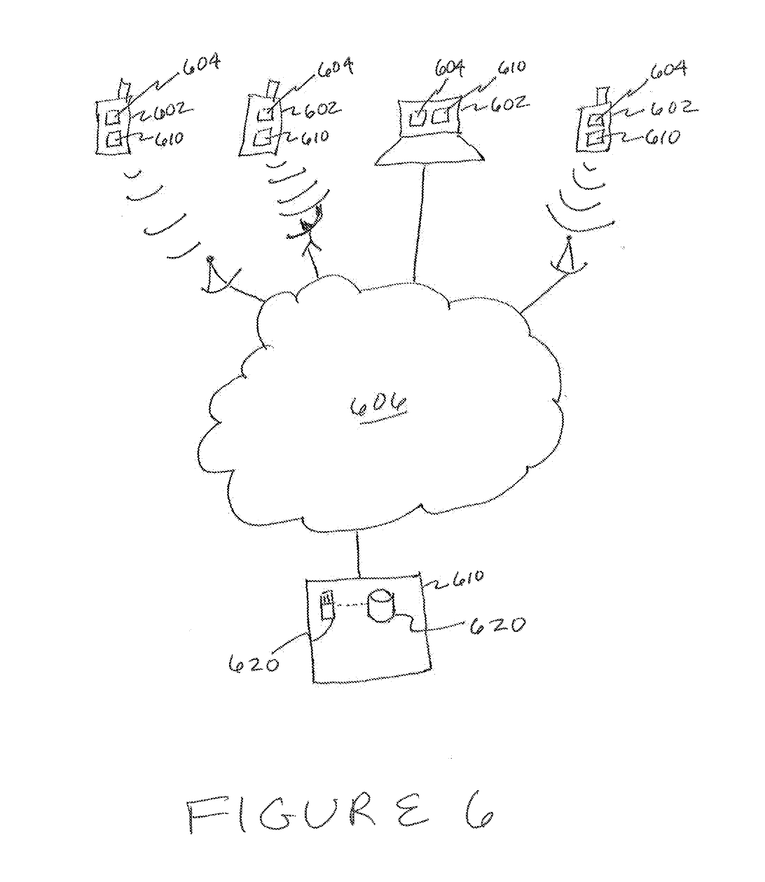

FIG. 6 illustrates an exemplary system for operation of the present invention. Included in the system may be a plurality of viewer devices 602, each uniquely identifiable and each having resident thereon one or more apps 604 in accordance with the discussion of the present invention herein. Of course, security may be applicable to allow for participation in the present invention, and as such the app 604 may exercise a security log-in (thus allowing for an initial set-up of a user account), may include a user profile, and may have its inbound and outbound communications subjected to one or more security and/or malware/anti-virus protocols. Further, such devices 602 may communicate (such as to indicate GPS location) via one or more networks 606 with a central hub 608. Communications with central hub 608 by app 604 may additionally comprise communications relating to other apps 610 on device 602.

Central hub 608 may also be in communication with third party elements 614, such as web sites, links, or the like. Similarly, central hub 608 may provide a pass through for direct communications between third party elements 614 and app 604 and/or other apps 610. Moreover, central hub may include monitoring, tracking, and storage capabilities 620, which may be resident in hardware and/or software. Needless to say, a GUI to access hub 608, such as by administrators and/or viewers, and/or GUIs for app 604 and apps 610, may be provided.

As such, the foregoing invention provides “game-ified” access to content. That is, content access is not based on a date perceived as arbitrary to a prospective viewer as set by a publisher of content (such as a release date of a movie promo set by a movie publisher, or a time-to-live value set by the publisher), but rather content access is based on a set of actions taken by the prospective viewer or viewers.

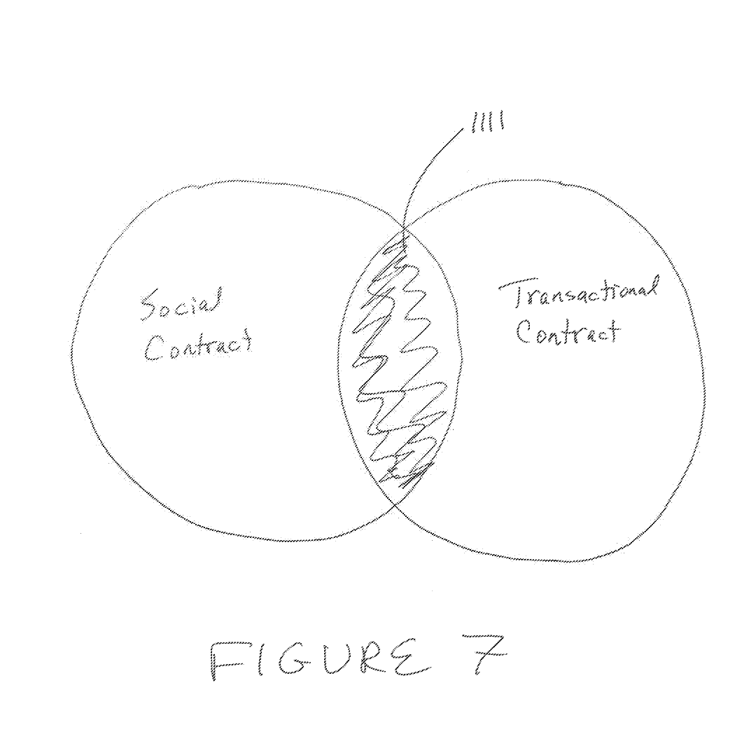

FIG. 7 illustrates conceptually a transaction, such as this “gamification of content,” in accordance with the instant disclosure. In the illustration, the instant transaction 1111 resides between a social contract (such as wherein a car allows a pedestrian to proceed), and a transactional contract (such as in which a painter is hired to paint a house). Accordingly, variations may be provided to incentivize entry into the type of contract proposed in the instant invention. For example, a viewer may be allowed to view unobfuscated content for a predetermined time period, such as for three seconds, where after, if the user retains interest in buying the content, the user may pay, for example, $0.50 to permanently obtain the content in its unblurred form. Likewise, four interconnected users, such as social media friends, may each wish to permanently obtain the content, and may accordingly each submit $0.20 per person, in satisfaction of a minimum value threshold of, for example, $0.50 as set by the provider of the content to provide the content to users permanently in unblurred form.

Accordingly, and in accordance with the disclosure herein, users may thus pledge, for example, time, money, services, or the like, in exchange for content (existing or not yet existing) that the users want to see or want others to see. By way of non-limiting example, a plurality of friends may pledge a certain amount of money, such as to a charity, if another friend provides unobfuscated, or progressively unobfuscated, content, such as content “proving” that an activity has been performed. Thereby, the instant disclosure may provide a platform to allow for, for example, charitable donation, such as wherein one user may “dare” another to generate content, such as the eating of a plate of wasabi, by way of non-limiting example, and if that requested content proving that the dare has been performed is uploaded, the pledging user will provide the pledged charitable donation.

The foregoing may be one type of “dare” provided in accordance with disclosed embodiments. That is, the disclosed systems and methods may allow for one user to dare another user, such as a contact, friend, follower, or followed person, to engage in an activity, and when said activity is engaged in, the “daring user” (i.e., she who is “daring” another) may provide the pledged dollars, either to the party performing the dare, to a charity of the daring user's choice, to a charity of the dare performer's choice, or the like. Thus, a dare may allow a user to tap into that user's social graph, such as through the user's contacts, in order to enhance, for example, charitable giving across the user's contacts.

Moreover, and in order to allow for the accomplishment of the foregoing purposes, the user may have access, such as within the app or application provided in accordance with the instant disclosure, to a list of the user's contacts. Likewise, the user may have access to a list of charities to which the user frequently gives, preapproved or pre-vetted charities, or the like. Additionally, in the context wherein moneys change hands as between users, the instant app or application may charge a transaction fee; however, this transaction fee may not be charged with regard to charitable giving.

Of course, the instant app or application may be likewise used in a variety of additional settings. For example, a dating application may provide an “unblur” of a prospective dating partner's profile, pictures, or the like, a life coach may charge to de-obfuscate motivational material, such as songs, pictures, videos, or the like, or one user may dare another user to stop smoking, and may have a plurality of friends pledge money to the smoking user, or a charity of the smoking user's choice, in order to enhance the likelihood that the smoking user will stop smoking.

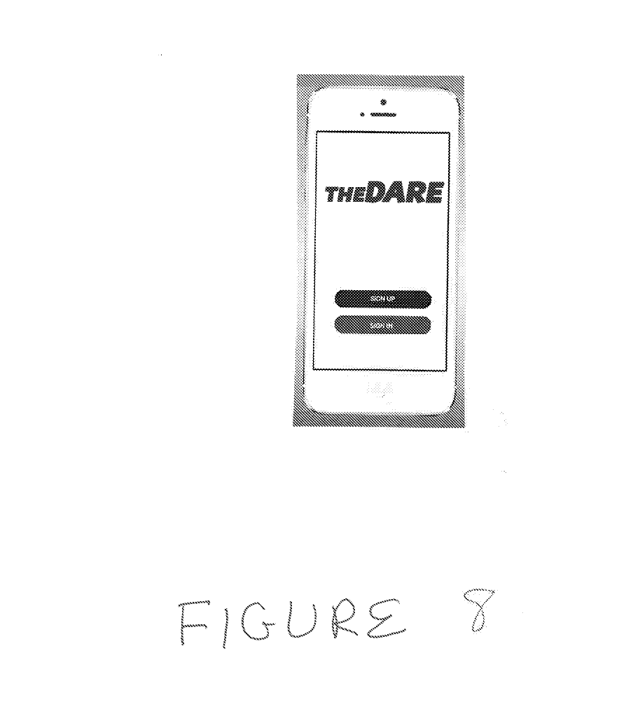

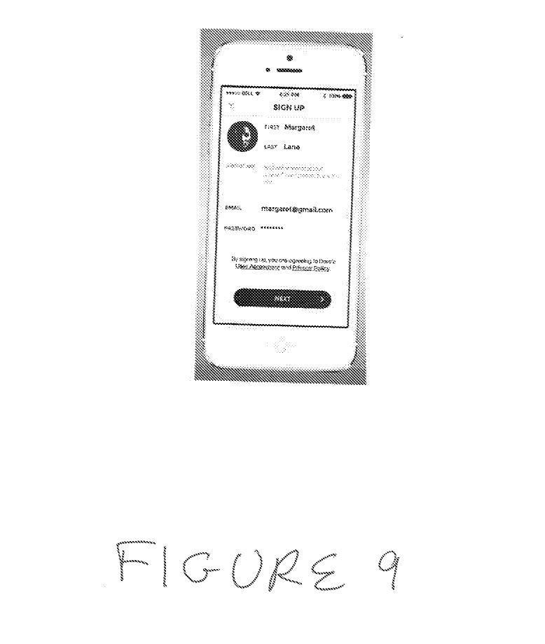

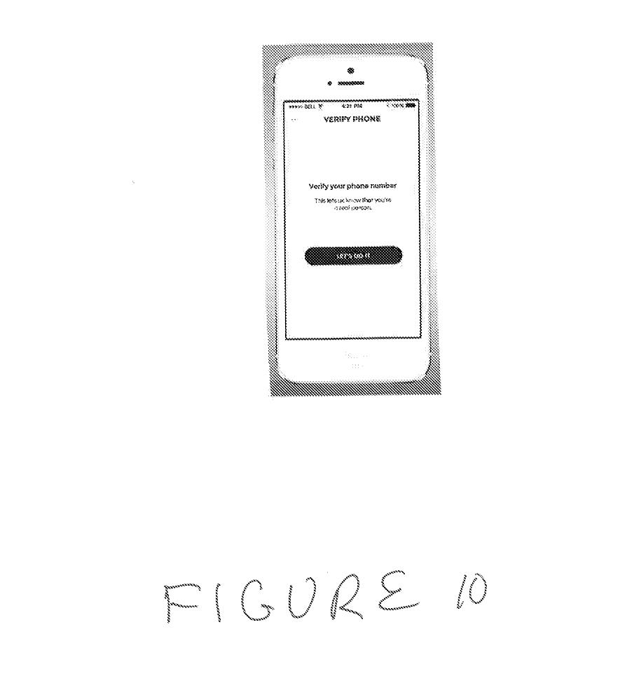

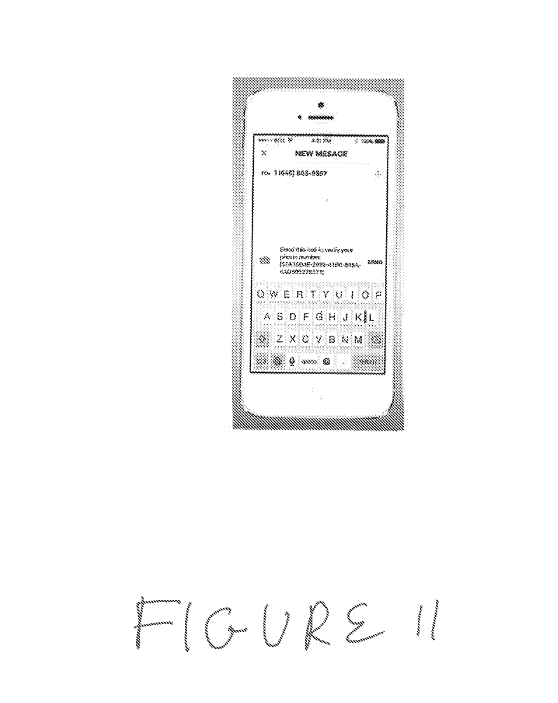

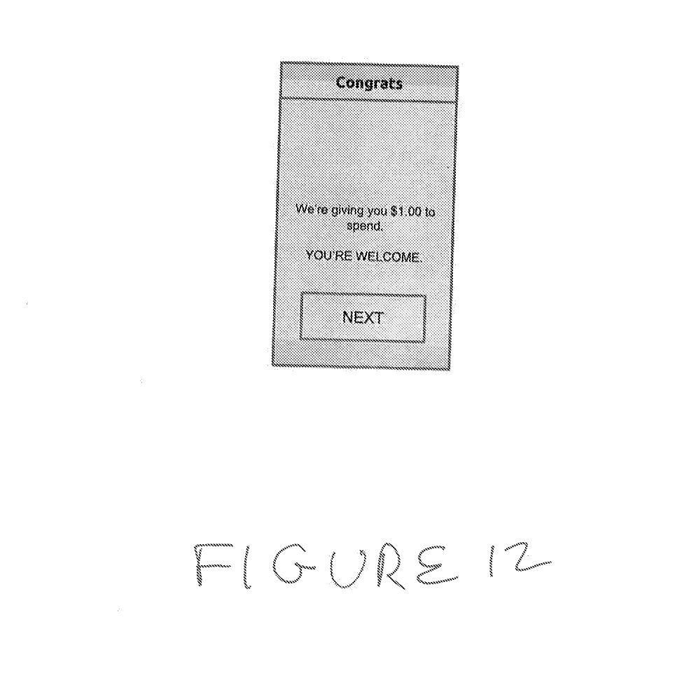

More particularly, and in accordance with the disclosure herein, FIGS. 8-12 illustrate the onboarding of a user to an app or application in accordance with the instant embodiments, wherein the application provides dares, and may provide obfuscation and de-obfuscation. As illustrated most particularly in FIG. 8, an existing user may sign in to the app or application using login credentials (as will be understood to the skilled artisan), or a new user may sign up for use of the app or application. As illustrated in FIG. 9, sign up may comprise the providing of a password, as well as profile information, which may be specific or non-specific, and which may or may not include entry of financial information, such as for verification for later use in dares. Verification of information, such as a telephone number in the illustration, is shown in the example of FIGS. 10 and 11. New users, with or without verification of particular data, may be provided, such as upon registration, with incentives to use the system. Such an incentive is illustrated in the example of FIG. 12.

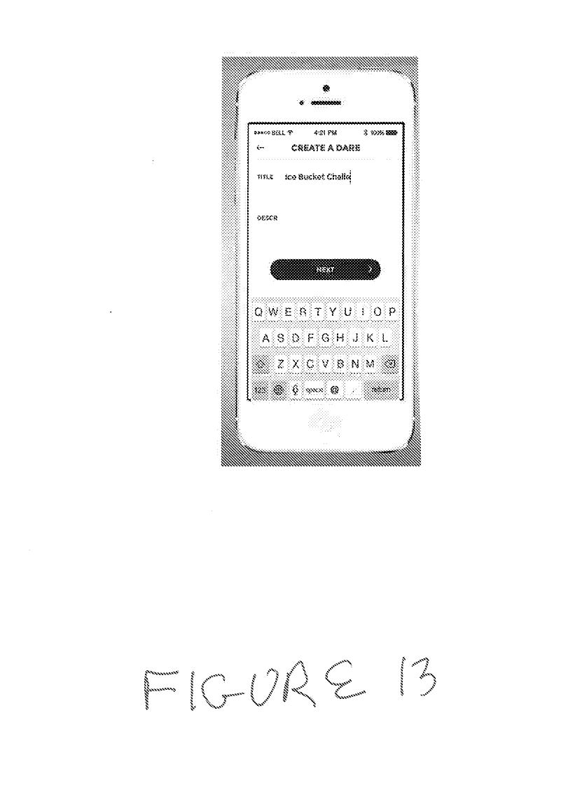

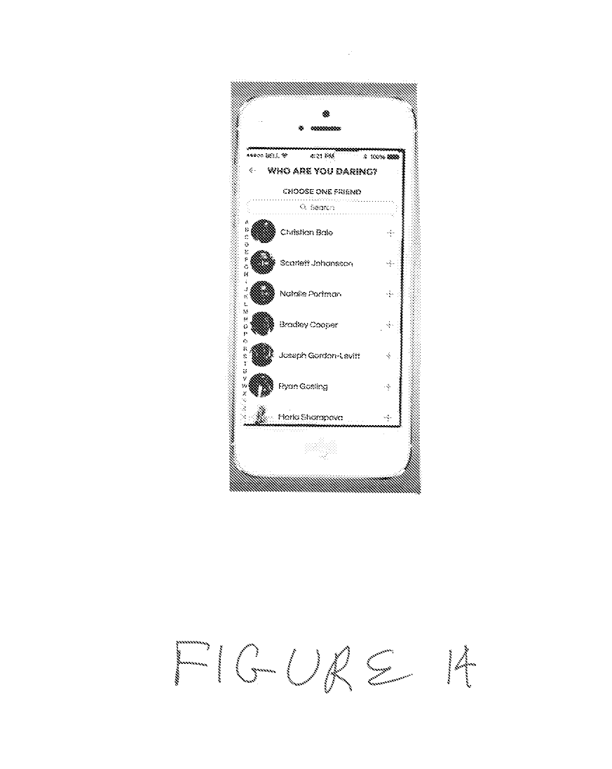

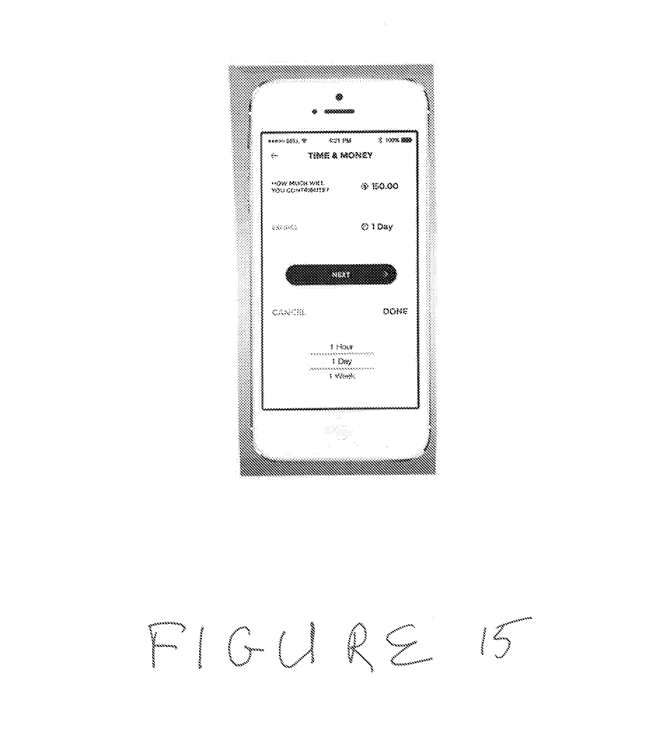

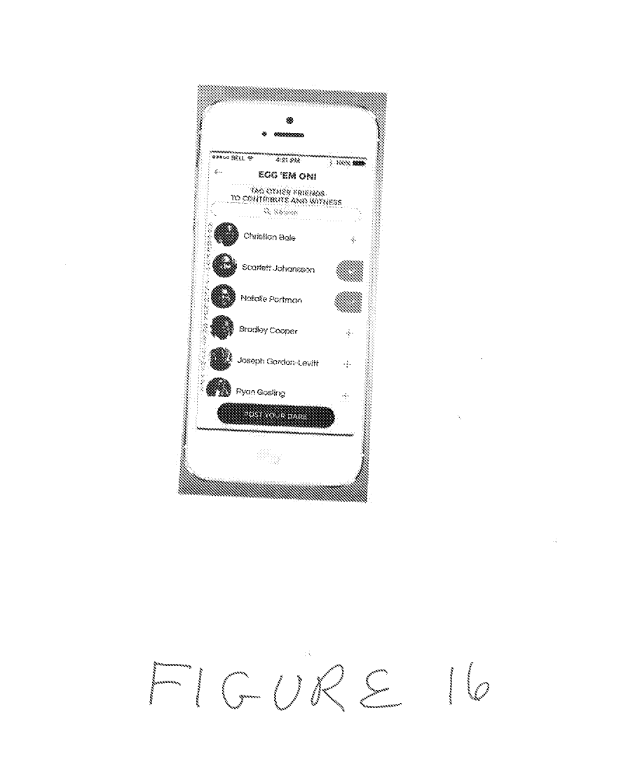

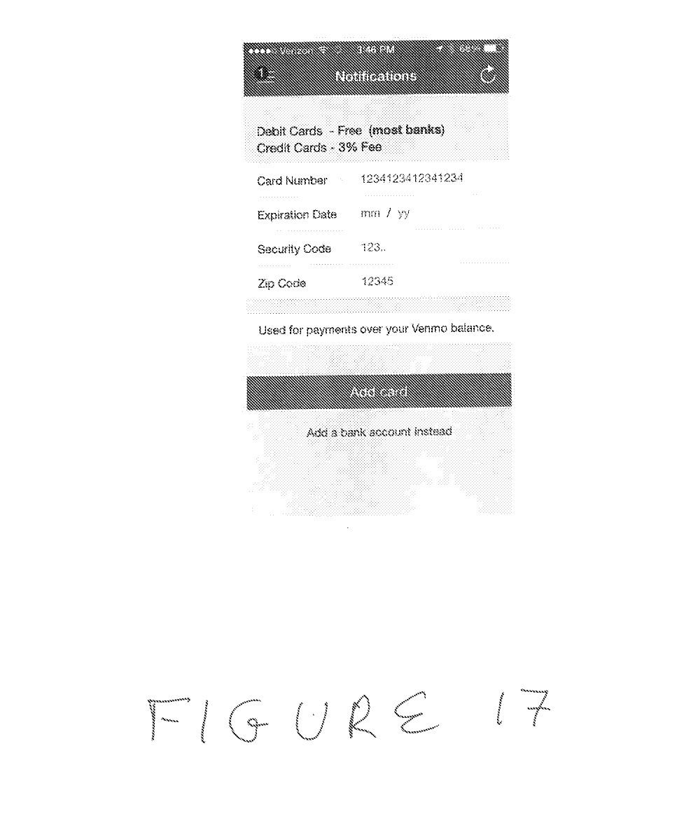

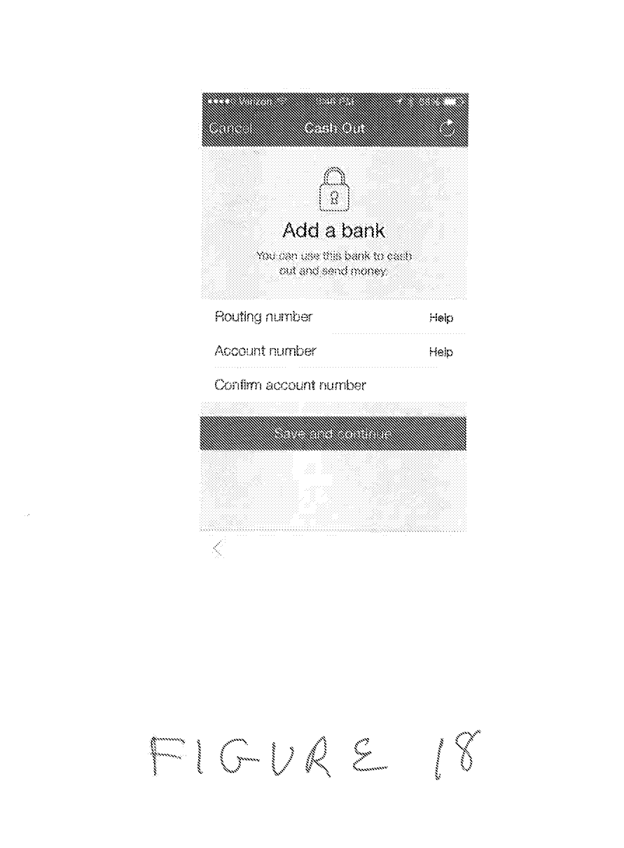

Once registered, a user may be enabled to use the system, such as in the creation of dares for available contacts as discussed throughout. For example, FIG. 13 illustrates the creation of a dare, including a title and description of the dare, and FIG. 14 illustrates a selection, such as from the user's contacts, friends, followers, or followed persons, of the person or persons whom the user wishes to dare. FIG. 15 is an exemplary illustration of the particulars of a dare, such as the timeframe in which the dare is to be performed, the contribution that the user pledges to make responsive to the performance of the dare, and the like. FIG. 16 illustrates selection of additional contacts, friends, followers, or followed persons who will also pledge in support of performance of the dare by the dared person or persons. Moreover, if not provided during the registration and onboarding processing, a user may provide financial information in support of his or her pledge in the dare, such as is illustrated in FIGS. 17 and 18.

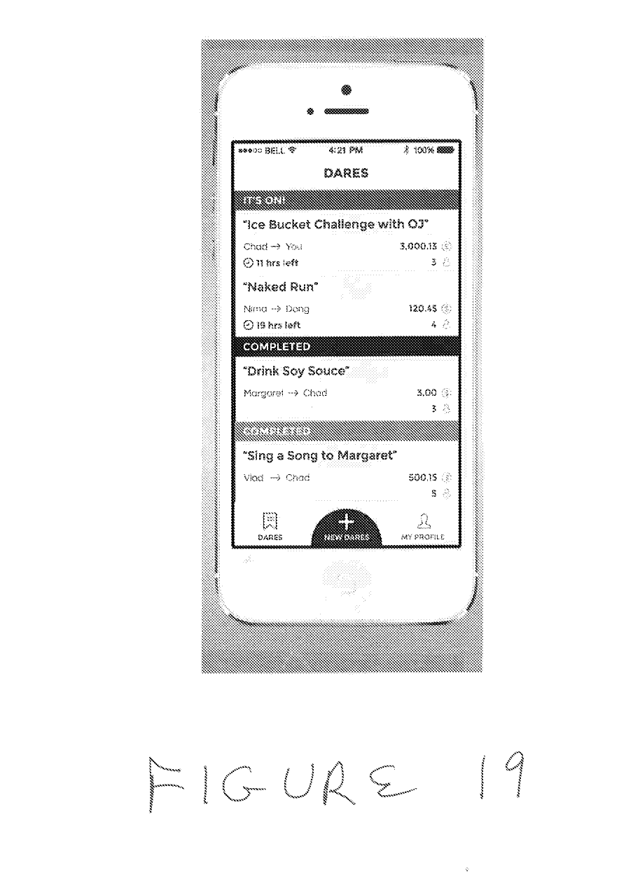

FIG. 19 illustrates reporting, such as may be provided in the app or application, regarding dares to the user, and dares pledged by the user. As illustrated in the example of FIG. 19, the dares may be tracked by time, dollars pledged, and the like, and the user may be able to add a new dare, participate as the dared person in any challenged dare, or access and modify the user's profile, at several or all points within the instant app or application.

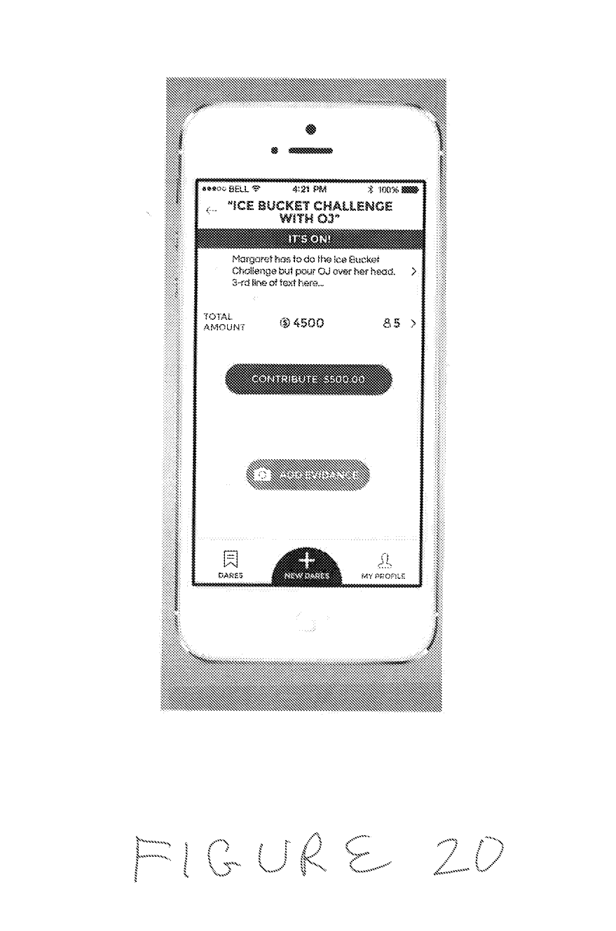

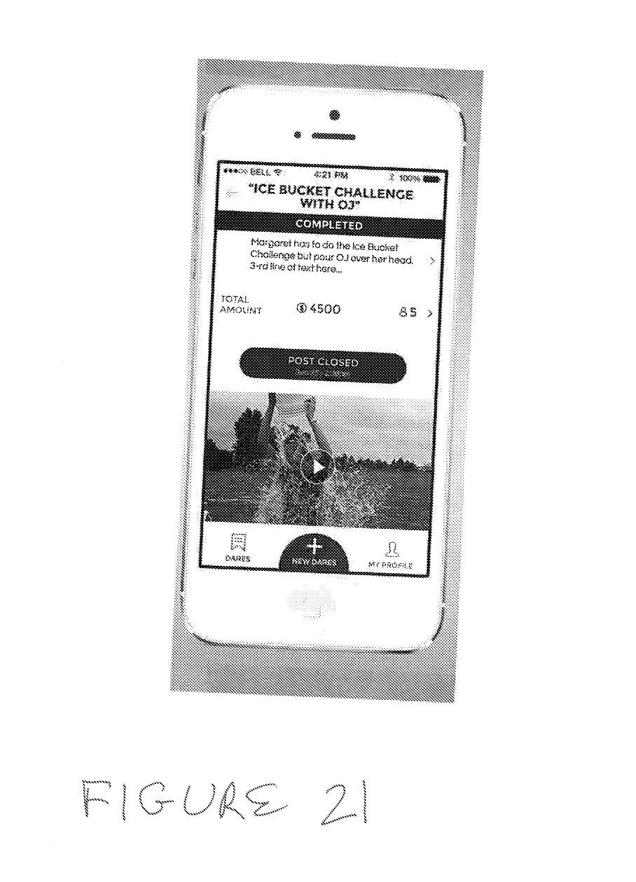

FIGS. 20 and 21 illustrate particulars of a specific dare. More particularly, the example of FIG. 20 illustrates a dare to a friend of the user, and illustrates that five other persons have pledged for the enumerated dare. Accordingly, the present user may choose to participate and pledge to the dare, or, the user may view or add evidence, such as in the form of photos, videos, emails, text, documents, or the like, “proving” that the dare has been performed. The example of FIG. 21 illustrates that the dare has ended with successful completion, and consequently the pledged amounts will be charged to the pledging users. Moreover, as illustrated in FIG. 21, evidence that the dare has been performed may be available to the pledging user while viewing the app or application.

The dare may be complete upon expiration of a given timeframe, or a dare may be complete upon the providing by the dared user of acceptable evidence of completion of the dare, by way of non-limiting example. To the extent the provided evidence of a dare is deemed unacceptable by one or more pledging users, or to the extent no evidence of performance of the dare is provided, a pledging user may request arbitration of the dare, wherein evidence may be requested and/or collected by the app or application, or by an administrator thereof, to illustrate successful or unsuccessful completion of the dare. To the extent that the arbitration process deems the dare completed, pledging users may be charged the pledged sum of money. To the extent the arbitration deems the dare to not be successfully completed, pledging users may not be charged, or may have previously charged funds returned.

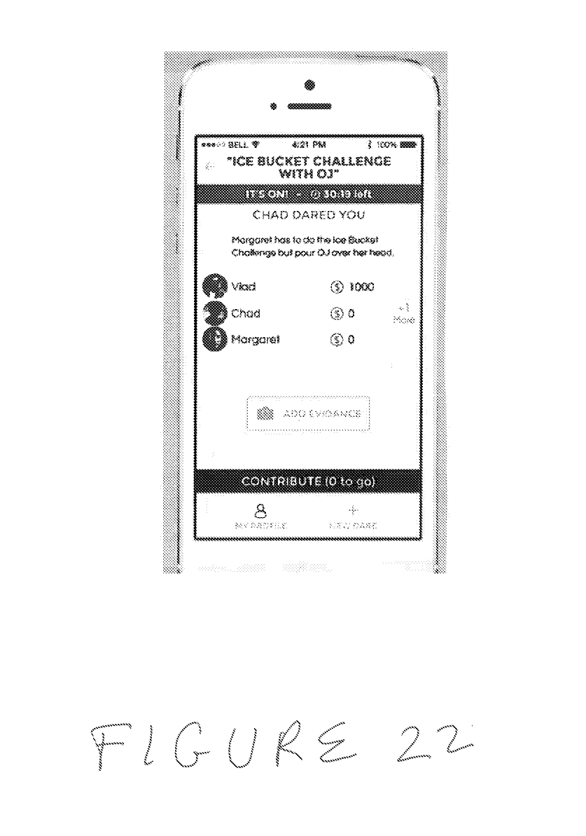

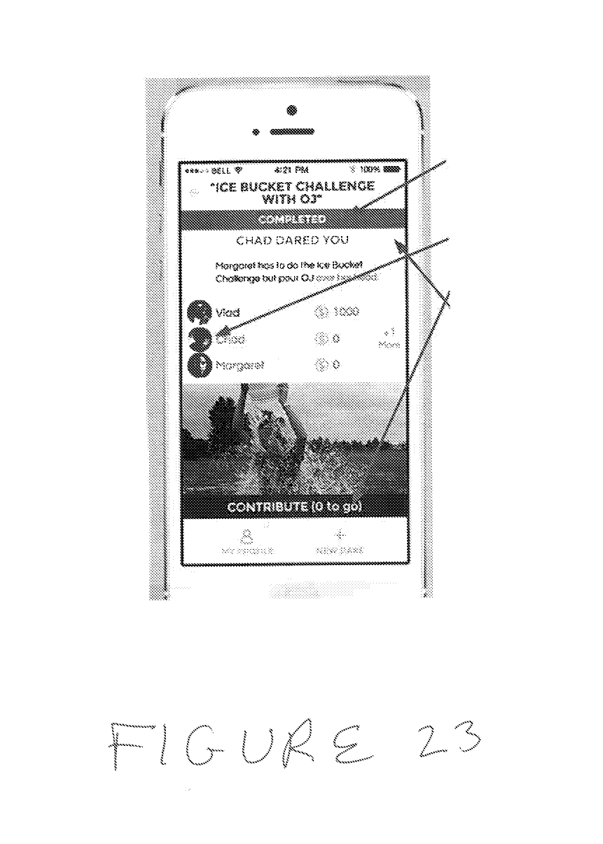

FIGS. 22 and 23 illustrate exemplary embodiments displays to a dared person. In the illustration of FIG. 22, a friend has dared the instant user to perform the ice bucket challenge, but with orange juice rather than ice water, and has pledged an illustrated amount if the dare is successfully performed. Moreover, the daring user has invited other friends to pledge, and has set a timeframe for performance of the dare of which 30 hours and 19 minutes remains prior to expiration. As illustrated in FIG. 23, upon completion of the dare, the dare user may provide evidence of completion of the dare, and the pledges may be charged to the pledging users.

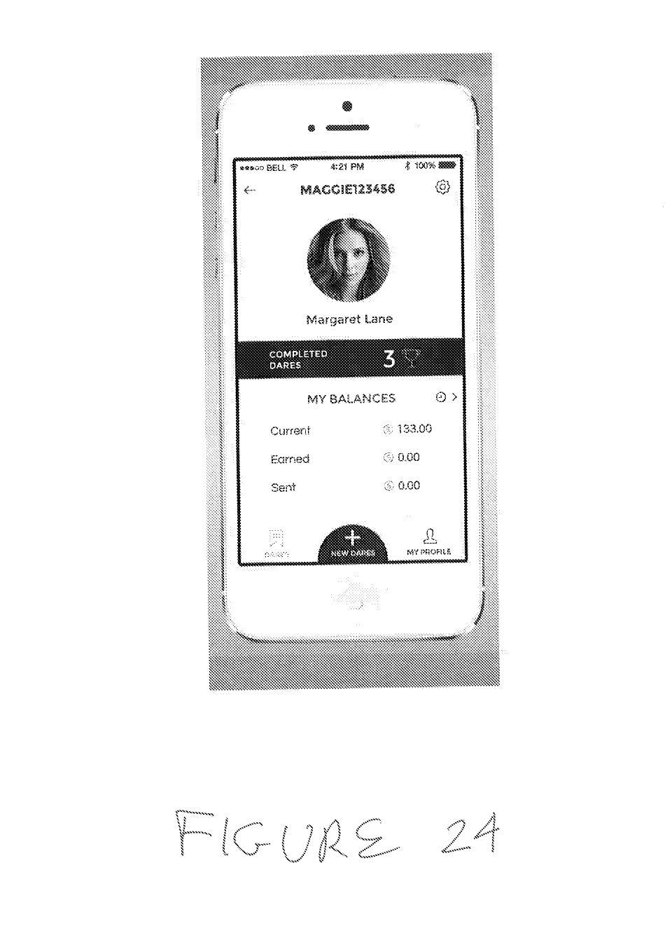

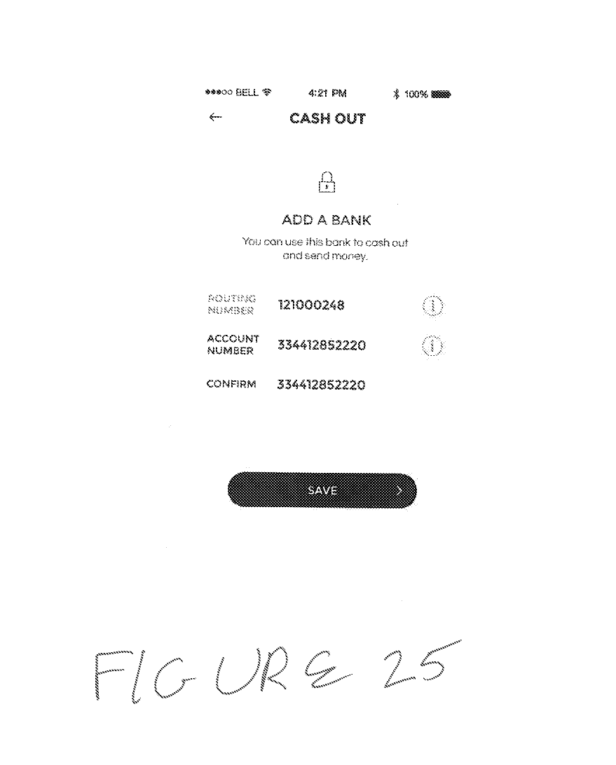

As referenced above, and as illustrated more particularly in FIG. 24, at some or multiple points during use of the instant app or application, the user may be enabled to access the user's profile. This profile access may not only comprise availability of modification to the user's profile, but may additionally provide the user rewards or awards for completed dares, a tracking of completed dares, a tracking of pledges on those completed dares, a tracking of pledge amounts the user is owed or owes, and the like. More particularly, the user may have access to the global transaction history of that user with regard to use of the instant app or application, such as including current dares and amounts earned, sent dares, pledges on dares, and the like. Moreover, and as part of the user's profile, the instant app or application may provide, as illustrated more particularly in example of FIG. 25, the ability for the user to cash out on available pledged amounts, enter financial information to allow for pledges, convert non-monetary points to dollars or vice versa, cash in or cash out rewards or awards, and the like.

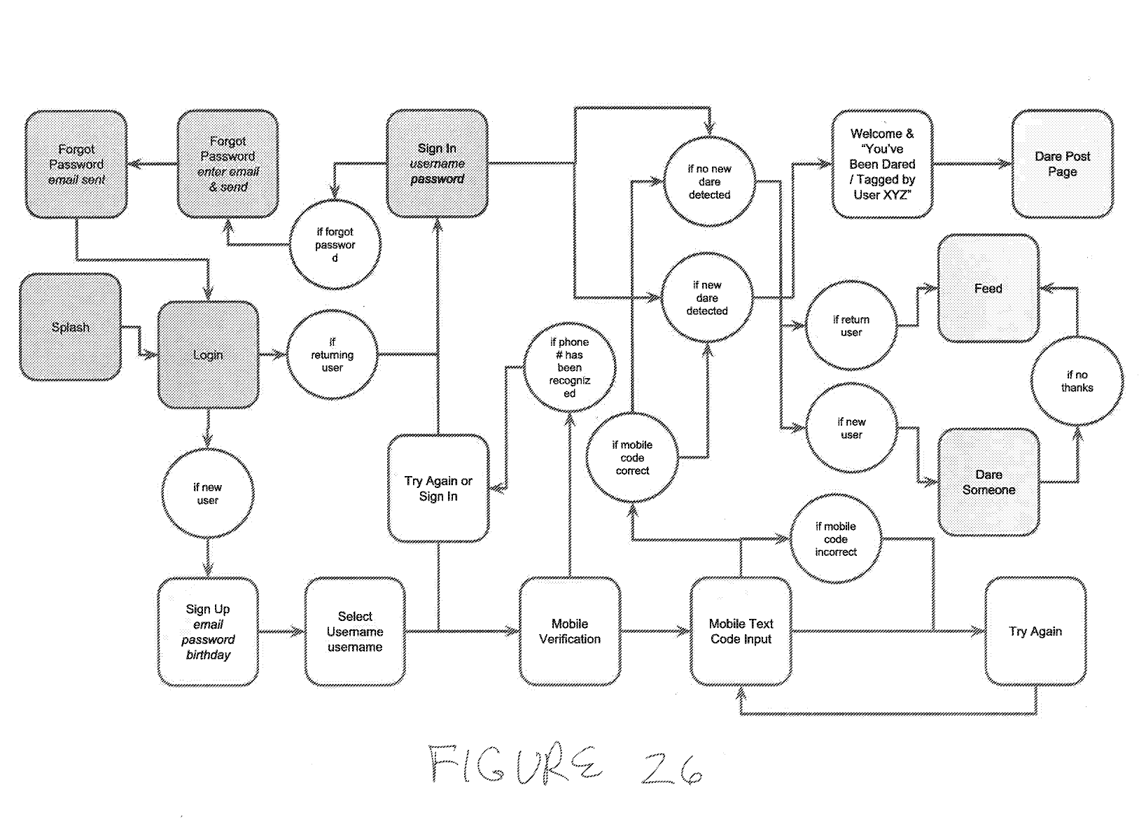

In FIGS. 26-30, exemplary illustrations are provided as process flows in accordance with the current systems and methods. More particularly, FIG. 26 illustrates an exemplary on-boarding process flow. As illustrated, a returning user may log in, using a username and password, while a new user may sign up, enter information, and select a user name and password. Moreover, a new user may be enabled to provide verification of information, such as of a mobile device. Both existing and new users may then proceed to the detection of a dare, where after the user may view his or her dare and pledge feed, or may pledge and dare someone else.

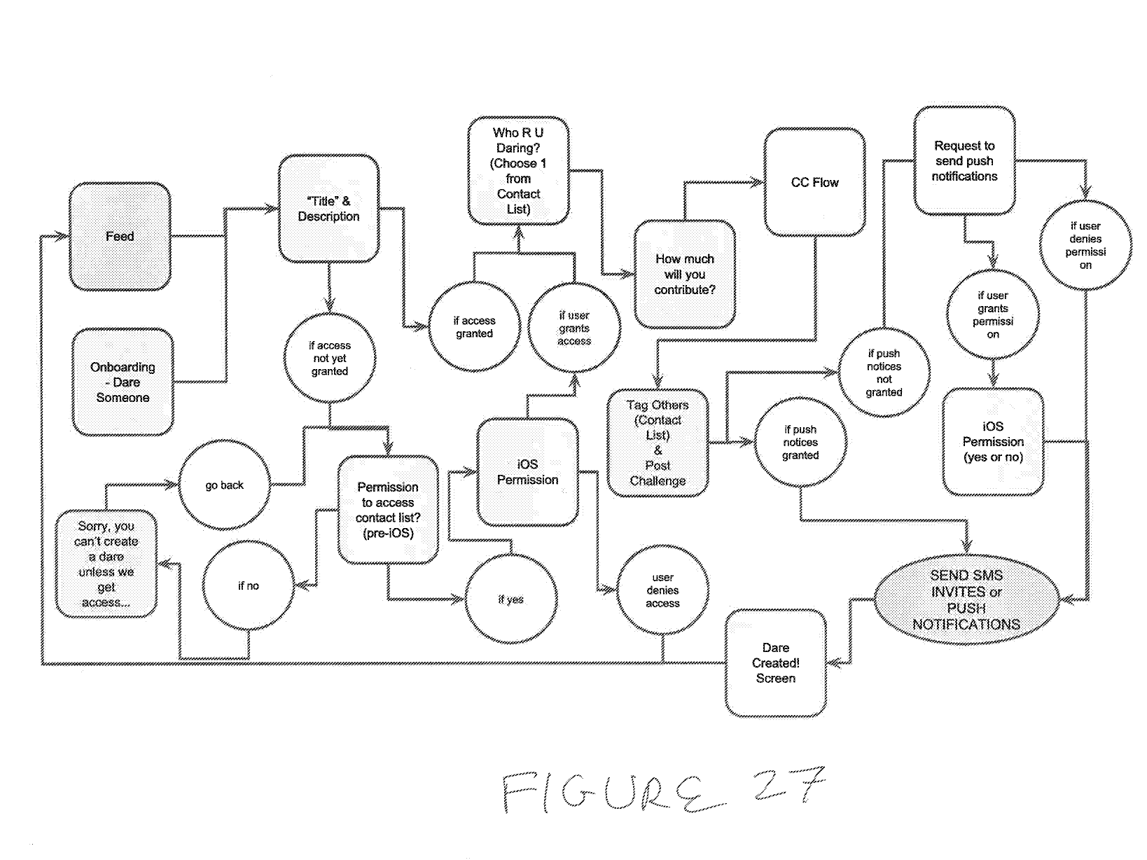

FIG. 27 is a flow diagram illustrating the exemplary creation of a dare. Following on boarding or log in, the user may be provided with a dare feed. Should the user wish to create a new dare, the user may provide a title and description, and may access the contacts list. The person to be dared may be selected from a contact list, a friend list, followers list, followed persons list, or the like. Once a person to dare is selected, a contribution pledge may be indicated, and others may be invited to pledge toward the dare. The system may then push invites and/or notifications out regarding the created dare.

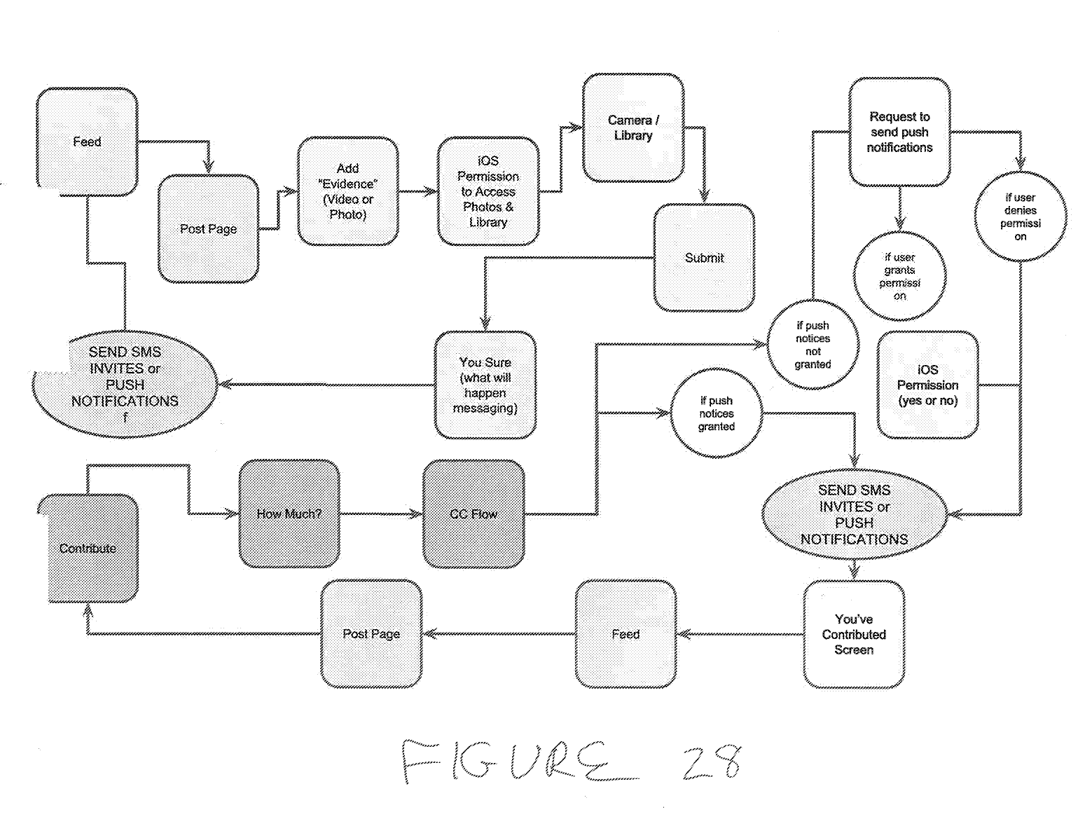

FIG. 28 is a flow diagram illustrating an exemplary pledge and contribution upon the providing of evidence that a dare has been performed. As illustrated in FIG. 28, responsive to a dare feed, evidence of the performance of a dare may be added such as using an on-device camera, or by selecting content from a library. Prior to this submission of evidence, a pledging person may indicate a contribution if a dare is performed, wherein the amount of the contribution is indicated and thereafter is shown on the user's in-app feed. It is this contribution the pledging person indicates will be given upon submission of evidence that the dare has been performed.

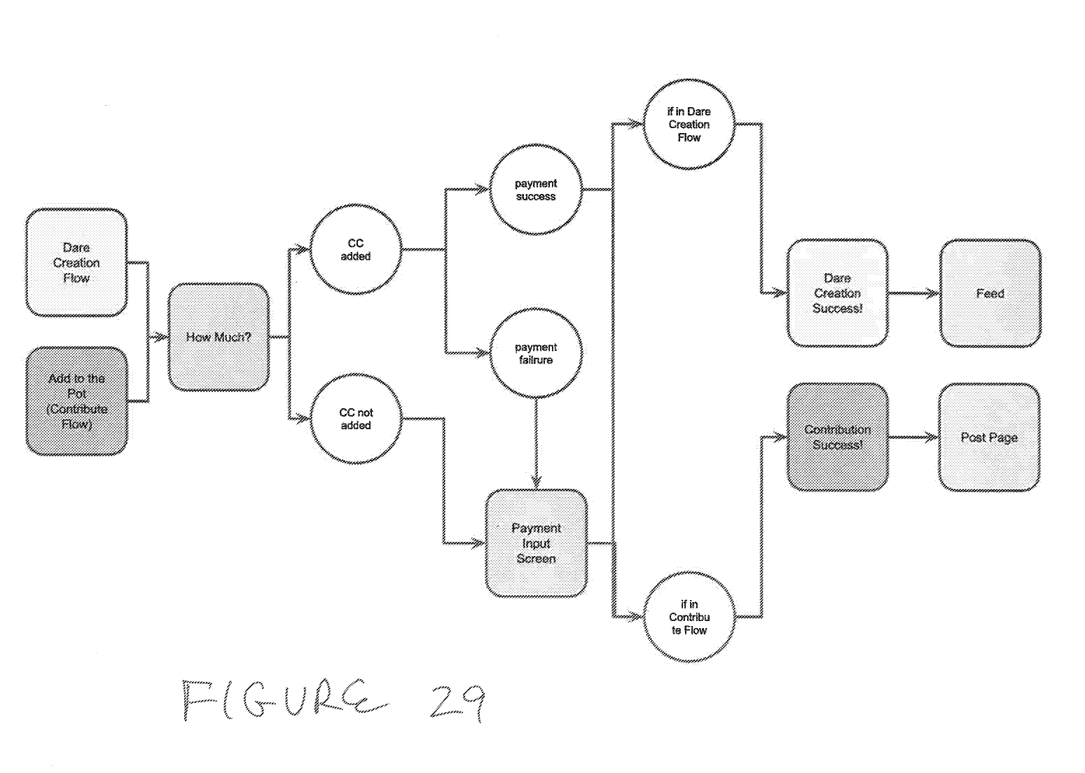

The flow diagram of FIG. 29 illustrates an exemplary embodiment of payments in accordance with a dare and pledge as disclosed herein. In the illustration, a dare is created, and a contribution indicated, such as by the process in FIG. 28. By way of example and as illustrated, credit card information may be entered wherefrom payment will be drawn, based on the pledge, upon successful completion of the dare. As shown, it may be preferable that entry of payment information is allowable only on existing dares, or by permanent storage in a user profile.

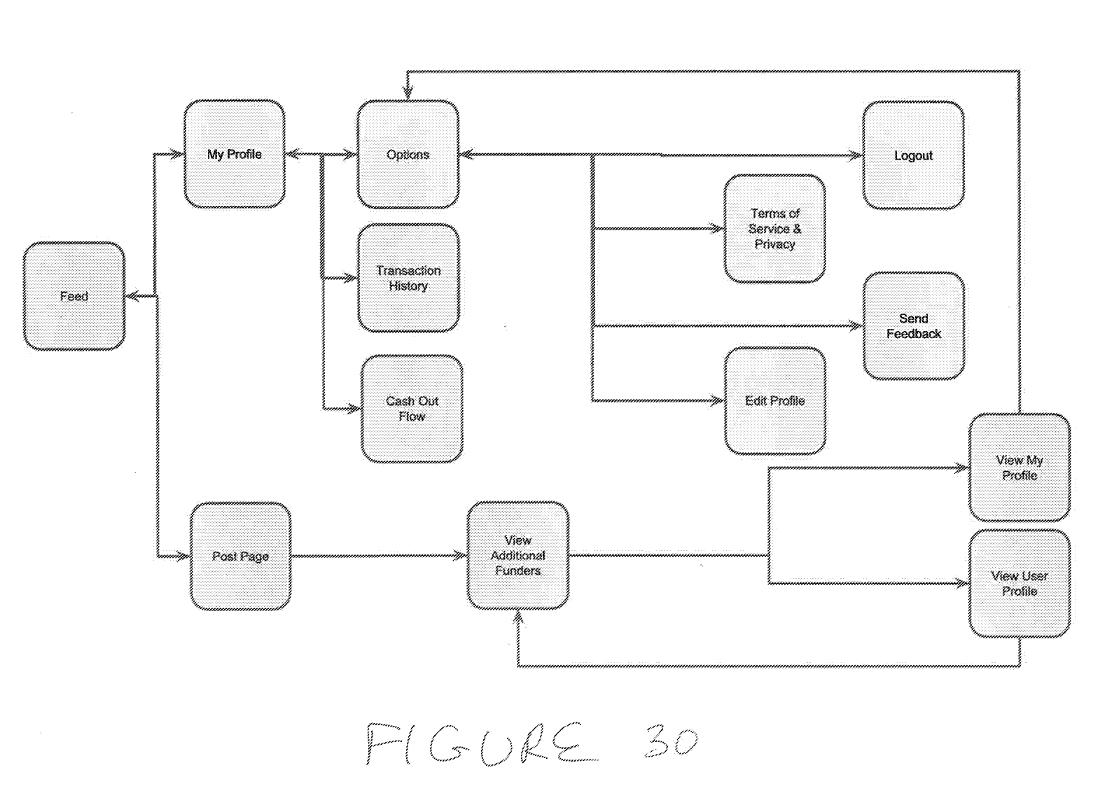

FIG. 30 is an exemplary illustration of a user's profile input and output. In the user's profile, the user may be provided with a variety of options to view and/or modify the user's profile. Additionally, the exchange of monies or money equivalence may be indicated in the user profile, and/or may be available from user profile. Furthermore, a transaction history associated with the user's profile may indicate the user's pledges and dares, both ongoing and completed. Other features may be available via the user profile, such as, but not limited to, customer service, feedback, arbitration requests, or the like.

Although the herein disclosed systems and methods have been described and illustrated in exemplary forms with a certain degree of particularity, it is noted that the description and illustrations have been made by way of example only. Numerous changes in the details of construction and combination and arrangement of parts and steps may be made. Accordingly, such changes are intended to be included in the invention, the scope of which is defined by the discussion herein and any claims appended hereto.

What is claimed is:

1. An apparatus, executed on a mobile device by at least one processor resident thereon, comprising:
an electronic viewing module suitable for providing a view of content;
a sending module suitable for sending at least one request for the content to at least one contact stored in a computing memory, wherein the request comprises criteria for generating the requested content;
an receiving module for receiving the requested content as indicative of an at least partial satisfaction of the criteria.

2. The apparatus of claim 1, wherein the criteria comprises a dare.
